(19) United States
(12) Patent Application Publication
(10) Pub. No.: US 2025/0163194 A1
(43) Pub. Date: May 22, 2025

(54) METHOD OF PRODUCING VINYLAMINE-CONTAINING POLYMERS

(71) Applicant: SOLENIS TECHNOLOGIES, L.P., Wilmington, DE (US)

(72) Inventors: Dan Whitfield, Holmfirth (GB); Shantanu P. Nikam, Wilmington, DE (US); Sachin Borkar, Wilmington, DE (US); Matthew Wright, Weddington, NC (US)

(73) Assignee: SOLENIS TECHNOLOGIES, L.P., Wilmington, DE (US)

(21) Appl. No.: 18/954,637

(22) Filed: Nov. 21, 2024

Related U.S. Application Data
(60) Provisional application No. 63/601,853, filed on Nov. 22, 2023.

(51) Int. Cl. C08F 8/12; D21H 17/34; D21H 21/10; D21H 21/18

(52) U.S. Cl. CPC C08F 8/12; D21H 17/34; D21H 21/10; D21H 21/18

(57) ABSTRACT

Provided is a method for the production of vinylamine-containing polymers. The method relates to the production of polyvinylamine compositions through hydrolysis of vinylcarboxamide-containing polymers, such as polymers and copolymers of N-vinylformamide. The process of hydrolyzing the vinylcarboxamide-containing polymer can be carried out at any location, such as on-site at papermaking facilities.

### CROSS-REFERENCE TO RELATED APPLICATIONS

This application claims the benefit of U.S. Provisional application No. 63/601,853, filed 22 Nov. 2023, the entire contents of which are hereby incorporated by reference.

### TECHNICAL FIELD

Provided is a method for the hydrolysis of vinylcarboxamide-containing polymer. The method relates to the production of polyvinylamine compositions through hydrolysis of vinylcarboxamide-containing polymers, such as polymers and copolymers of N-vinylformamide. The process of hydrolyzing the vinylcarboxamide-containing polymer can be carried out at any location, such as on-site at paper facilities.

### BACKGROUND

Polyvinylamine (PVAM) and its compositions are commonly used in the manufacture of paper, board or the like. These polymers are typically manufactured through the hydrolysis of N-vinylcarboxamide, such as polymers and copolymers of N-vinylformamide. However, delivering PVAM polymers to customers involve high transportation and storage costs due to the large volumes involved. Today, commercial products have actives/solid content generally ranging from about 5 weight % (wt. %) to about 50 wt. %.

The molecular weight (Mw) of the PVAM backbone was found to be an important parameter for its performance in the manufacture of paper and paperboard. The long backbone provides sufficient dimensions for bonding and linkages between the fiber surfaces. The good formation, bonding ability and excellent dewatering provided by the PVAM polymer are beneficial for the strength properties of the final paper or board.

In general, higher molecular weight PVAMs provide a higher performance boost and allow faster production. The conventional solution polymerization method is limited in its ability to achieve higher molecular weights while keeping the reactant residuals low. However, using other polymerization techniques involve complex manufacturing process which lead to added product costs.

In order to achieve higher molecular weights with the conventional techniques the products need to be produced at progressively lower actives/solid content. Additionally, the hydrolysis process further reduces the actives/solid content of the product. Thus, increasing the transportation cost involved with shipping of less concentrated products. This also increases the environmental impact by increasing the carbon footprint associated with the usage of the product.

Thus, PVAM polymers in their conventional form have inherent limitations in the form of shelf-life, transportation costs of lower solids/actives polymer, and in some cases limited by molecular weight.

The current method relates to production of Polyvinylamine compositions, by transporting the N-vinylcarboxamide-containing polymers to a customer or remote location and carrying out hydrolysis at the paper production site. Current invention allows for production and transportation of polymers with higher molecular weight and up to 100% solids content.

The polymers produced with this method show improved de-watering performance and strength properties when compared to polymers in the prior art. The faster dewatering would allow for the energy savings in the dryer section and a faster rate of production. Making the paper production process more sustainable.

Though PVAM and its compositions are fairly stable, the PVFA pre-polymers tend to be more stable over long periods of time. Employing an on-site hydrolysis will allow on-demand hydrolysis of more stable PVFA, thus further enhancing the shelf-life of the product.

The hydrolysis level of PVFA dictates the particle charge density (PCD) of the polymer. Every paper production unit has a unique tolerance range of PCD requirement. Producing PVAMs with PCD specific for each individual customer would be challenging, in-efficient and an expensive operation. Another advantage of the current process is that tolerance range can be easily addressed by targeting required hydrolysis level in the on-site hydrolysis process.

The present disclosure will hereinafter be described in conjunction with the following drawing figures.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Provided is a method of producing a vinylamine-containing polymer at remote or satellite production sites. A vinylcarboxamide-containing polymer, such as a vinylformamide-containing polymer can be shipped to a customer location from the site where the vinylcarboxamide containing polymer was synthesized for hydrolysis. The vinylcarboxamide-containing polymer, is added to an aqueous solution and onsite hydrolysis is carried out in the presence of acids or bases. Depending on the application of use the pH of the hydrolyzed polymer can be adjusted in the suitable range before application.

The vinylcarboxamide-containing polymer has at least one N-vinylcarboxamide monomer of Formula I below,

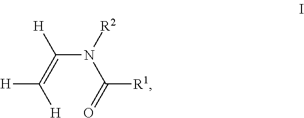

wherein R¹ and R², independently of one another, are H or C₁ to C₆ alkyl, and optionally one or more vinyl monomer(s) which are different from Formula I.

### BRIEF DESCRIPTION OF THE DRAWINGS

The present disclosure will hereinafter be described in conjunction with the following drawing figures.

FIG. 1, depicts a graph showing results of drainage performance of a conventional drainage system versus the present system.

### DETAILED DESCRIPTION

The following detailed description is merely exemplary in nature and is not intended to limit the invention or the application and uses of the invention. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

The term “active solids” used for the polymer of the present composition herein represents the total weight of the polymer as a percentage of a solution of all the monomers and modifying compounds used for making the polymer on dry weight basis. The term “mole percent” of a monomer in a polymer refers to percentage of specific monomer present in the polymer as a repeating unit. The term “weight percent” or “weight ratio” of a material used in the present invention represents the percentage or the ratio of the “active solids” of this material versus other components.

As used herein, the term “paper” refers to paper products including tissue paper, paper towels and paper board.

Provided is a method of producing a vinylamine-containing polymer at remote or satellite production sites. A vinylcarboxamide-containing polymer, such as a vinylformamide-containing polymer can be shipped to a customer location from the site where the vinylcarboxamide containing polymer was synthesized, for hydrolysis. The vinylcarboxamide-containing polymer, is added to an aqueous solution and onsite hydrolysis is carried out in the presence of acids or bases. Depending on the application of use, the pH of the hydrolyzed polymer can be adjusted to the suitable range before application.

The vinylcarboxamide-containing polymer has at least one N-vinylcarboxamide monomer of Formula I below,

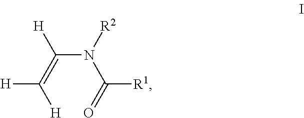

wherein R¹ and R², independently of one another, are H or C₁ to C₆ alkyl, and optionally one or more vinyl monomer(s) which are different from Formula I.

In some aspects of the method, the solid vinylcarboxamide carboxamide containing polymer is a polymer or copolymer of N-vinylformamide.

In other aspects of the method, the N-vinylcarboxamide monomer is selected from N-vinylformamide, N-vinyl-N-methylformamide, N-vinylacetamide, N-vinyl-N-methylacetamide, N-vinyl-N-ethylacetamide, N-vinylpropionamide and N-vinyl-N-methyl-propionamide, N-vinylbutyramide, and combinations thereof.

Vinyl monomer refers to monomers which have (H₂C═C—) group in their structure. Vinyl monomers could alternatively be defined as ethylenically unsaturated monomers. An ethylenically unsaturated monomer herein is a monomer containing at least one C₂ unit whose two carbon atoms are linked by a carbon-carbon double bond. In the case of hydrogen atoms as the only substituent, this is ethylene. In the case of substitution with three hydrogen atoms, a vinyl derivative is present. In the case of substitution with two hydrogen atoms, an E/Z isomer or an ethene-1,1-diylderivative is present. Mono-ethylenically unsaturated monomer means here that exactly one C₂ unit is present in the monomer.

In the case of a cationically charged group of a given molecule or class of molecules, salt form means that a corresponding anion ensures charge neutrality. Such anions are for example chloride, bromide, hydrogen sulfate, sulfate, hydrogen phosphate, methyl sulfate, acetate and formate. In the case of an anionically charged group of a specified compound or compound class, salt form means that a corresponding cation ensures charge neutrality. Such cations are for example cations of the alkali metals, alkaline earth metals, ammonia, alkylamines and alkanolamines. Examples of some of the salts are Li+, Na+, K+, Rb+, Cs+, Mg2+, Ca2+, Sr2+, Ba2+and NH4+.

In some aspects of the method, the vinyl monomer(s) is/are selected from monoethylenically unsaturated carboxylic acids salt forms, such as monoethylenically unsaturated C₃-C₈ mono-or dicarboxylic acids or salts thereof. Examples include acrylic acid, sodium acrylate, methacrylic acid, sodium methacrylate, dimethacrylic acid, maleic acid, fumaric acid, itaconic acid, mesaconic acid, citraconic acid, methylene malonic acid, allylacetic acid, vinyl acetic acid, crotonic acid, and combinations thereof.

In some aspects of the method, the vinyl monomer(s) from monoethylenically unsaturated sulfonic acids and salts thereof, such as vinyl sulfonic acid, acrylamido-2-methylpropane sulfonic acid, methacrylamido-2-methylpropane sulfonic acid, allylsulfonic acid, methallysulfonic acid, sulfoethyl acrylate, sulfoethyl methacrylate, sulfopropyl acrylate, sulfopropyl methacrylate, 2-hydroxy-3-methacryloxypropyl sulfonic acid, and styrene sulfonic acid.

In some aspects of the method, the vinyl monomer(s) is/are selected from monoethylenically unsaturated phosphonic acids and salts thereof, such as vinylphosphonic acid, vinylphosphonic acid monomethyl ester, allylphosphonic acid, allylphosphonic acid monomethyl ester, acrylamidomethylpropyl phosphonic acid, and acrylamidomethylene phosphonic acid.

In some aspects of the method the vinyl monomer(s) is/are selected from monoethylenically unsaturated C₃-C₈ mono-or dicarboxylic acids, monoethylenically unsaturated sulfonic acids, vinylphosphonic acids and salts thereof. The monomer can be chosen from monoethylenically unsaturated C₃-C₈ mono-or dicarboxylic acids, acrylamido-2-methylpropanesulfonic acid, methacrylamido-2-methylpropanesulfonic acid, vinylphosphonic acids and salts thereof.

In some aspects of the method, the vinyl monomer(s) is/are selected from monoesters of α,β-ethylenically unsaturated monocarboxylic acids with C₁-C₃₀ alkanols, monoesters of α,β-ethylenically unsaturated monocarboxylic acids with C₂-C₃₀ alkanediols, diesters of α,β-ethylenically unsaturated dicarboxylic acids with C₁-C₃₀ alkanols or C₂-C₃₀ alkanediols, primary amides of α,β-ethylenically unsaturated monocarboxylic acids, N-alkylamides of α,β-ethylenically unsaturated monocarboxylic acids, N,N-dialkylamides of α,β-ethylenically unsaturated monocarboxylic acids, nitriles of α,β-ethylenically unsaturated monocarboxylic acids, dinitriles of α,β-ethylenically unsaturated dicarboxylic acids, esters of vinyl alcohol with C₁-C₃₀ monocarboxylic acids, esters of allyl alcohol with C₁-C₃₀ monocarboxylic acids, N-vinyl lactams, nitrogen-free heterocycles with an α,β-ethylenically unsaturated double bond, vinyl aromatics, vinyl halides, vinylidene halides, C₂-C₈ monoolefins and C₄-C₁₀ olefins with exactly two double bonds that are conjugated, and combinations thereof.

In some aspects of the method, the vinyl monomers can be chosen from monoesters of α,β-ethylenically unsaturated monocarboxylic acids with C₁-C₃₀ alkanols, for example methyl acrylate, methyl methacrylate, methyl ethacrylate (methyl 2-ethyl acrylate), ethyl acrylate, ethyl methacrylate, ethyl ethacrylate (ethyl 2-ethyl acrylate), n-butyl acrylate, n-butyl methacrylate, isobutyl acrylate, isobutyl methacrylate, tert-butyl acrylate, tert-butyl methacrylate, tert-butyl ethacrylate, n-octyl acrylate, n-octyl methacrylate, 1,1,3,3-tetramethyl butyl acrylate, 1,1,3,3-tetramethyl butyl methacrylate, 2-ethylhexyl acrylate, and combinations thereof.

In some aspects of the method, monoesters of α,β-ethylenically unsaturated monocarboxylic acids with C₂-C₃₀ alkanediols can be for example, 2-hydroxyethyl acrylate, 2-hydroxyethyl m ethacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutylacrylate, 3-hydroxybutyl methacrylate, 4-hydroxybutylacrylate, 4-hydroxybutyl methacrylate, 6-hydroxyhexyl acrylate, 6-hydroxyhexyl methacrylate, and combinations thereof.

In some aspects of the method, primary amides of α,β-ethylenically unsaturated monocarboxylic acids can be, for example, acrylic acid amide and methacrylic acid amide.

In some aspects of the method, N-alkyl amides of α,β-ethylenically unsaturated monocarboxylic acids are for example N-methylacrylamide, N-methylmethacrylamide, N-isopropylacrylamide, N-isopropylmethacrylamide, N-ethyl acrylamide, N-ethyl methacrylamide, N-(n-propyl)acrylamide, N-(n-propyl)methacrylamide, N-(n-butyl)acrylamide, N-(n-butyl)methacrylamide, N-(tert-butyl)acrylamide, N-(tert-butyl)methacrylamide, N-(n-octyl)acrylamide, N-(n-octyl)methacrylamide, N-(1,1,3,3-tetramethylbutyl)acrylamide, N-(1,1,3,3-tetramethylbutyl) methacrylamide, N-(2-ethylhexyl) acrylamide and N-(2-ethylhexyl-methacrylamide.

In some aspects of the method, the N,N-dialkylamides from α,β-ethylenically unsaturated monocarboxylic acids can for be, N,N-example, N,N-dimethylacrylamide, dimethylmethacrylamide, or a combination thereof.

In some aspects of the method, nitriles from α,β-ethylenically unsaturated monocarboxylic acids can be, for example, acrylonitrile, methacrylonitrile or a combination thereof.

In some aspects of the method, esters of vinyl alcohol with C₁-C₃₀ monocarboxylic acids can be, for example, vinyl formate, vinyl acetate, vinyl propionate, and combinations thereof.

In some aspects of the method, N-vinyl lactams can be, for example, N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, and combinations thereof.

In some aspects of the method, the vinyl monomer(s) can be selected from vinylaromatics, for example, styrene and methylstyrene, vinyl halides such as vinyl chloride and vinyl fluoride, vinylidene halides such as vinylidene chloride and vinylidene fluoride, C₂-C₈ monoolefins such as ethylene, propylene, isobutylene, 1-butene, 1-hexene, and 1-octene. C₄-C₁₀ olefins with exactly two double bonds that are conjugated, for example, butadiene and isoprene, and combinations thereof.

In some aspects of the method, the vinyl monomer(s) is/are selected from monoethylenically unsaturated monomers and salts thereof, which carries at least one secondary or tertiary amino group and whose at least one secondary or tertiary amino group is protonated at pH value 7, and which does not carry a group which is deprotonated at pH value 7, or esters of α,β-ethylenically unsaturated monocarboxylic acids with amino alcohols, mono-and diesters of α,β-ethylenically unsaturated dicarboxylic acids with amino alcohols, amides of α,β-ethylenically unsaturated monocarboxylic acids with dialkylated diamines, N-vinylimidazole, vinylpyridine, and combinations thereof.

In some aspects of the method, the vinyl monomer(s) can be chosen from monoethylenically unsaturated monomers having a quaternized nitrogen as the sole charge bearing group at a pH value of 7, a salt form of an N-alkyl-N′-vinylimidazolium, a salt form of an N-alkylated vinylpyridinium, a salt form of an acrylamidoalkyl trialkylammonium, a salt form of a methacrylamidoalkyl trialkylammonium, and combinations thereof. For example, the salt form of N-alkyl-N′-vinylimidazolium can be 1-methyl-3-vinylimidazol-1-ium chloride, 1-methyl-3-vinylimidazol-1-ium methyl sulfate, 1-ethyl-3-vinylimidazol-1-ium chloride. For example, a salt form of an N-alkylated vinylpyridinium can be 1-methyl-4-vinylpyridin-1-ium chloride, 1-methyl-3-vinylpyridin-1-ium chloride, 1-methyl-2-vinylpyridin-1-ium 1-ethyl-4-vinylpyridin-1-ium chloride. A salt form of an acrylamidoalkyl trialkylammonium is acrylamidoethyl trimethylammonium chloride (trimethyl-[2-(prop-2-enoylamino)ethyl]ammonium chloride), acrylamidoethyl diethylmethylammonium chloride (diethyl methyl-[3-(prop-2-enoylamino)ethyl]ammonium chloride), acrylamidopropyl trimethylammonium chloride (trimethyl-[3-(prop-2-enoylamino)propyl]ammonium chloride) and acrylamidopropyl diethylmethylammonium chloride (diethyl methyl-[3-(prop-2-enoylamino)propyl]ammonium chloride). For example, a salt form of a methacrylic alkyl trialkylammonium is methacrylamidoethyl trimethylammonium chloride (trimethyl-[2-(2-methylprop-2-enoylamino)ethyl]ammonium chloride), methacrylamidoethyl diethylmethylammonium chloride (diethyl-methyl-[3-(2-methylprop-2-enoylamino)ethyl]ammonium chloride), methacrylamidopropyl trimethylammonium chloride (trimethyl-[3-(2-methyl-prop-2-enoylamino)propyl]ammonium chloride), methacrylamidopropyl diethylmethylammonium chloride (diethyl methyl-[3-(2-methylprop-2-enoylamino)propyl]ammonium chloride), and combinations thereof.

In some aspects of the method the vinyl monomer(s) is/are selected from diallyl-substituted amine which has exactly two ethylenic double bonds and is quaternized or protonated at pH 7 and salt forms thereof, such as diallylamine, methyldiallylamine, diallyldipropylammonium chloride, and diallyldibutylammonium chloride.

In some aspects of the method, the vinyl monomer(s) is/are selected from diallyl dimethylammonium chloride, diallyl diethylammonium chloride, and a combination thereof.

In some aspects of the method, the vinyl monomer(s) is/are selected from tetraallylammonium chloride, triallylamine, methylenebisacrylamide, glycol diacrylate, glycol dimethacrylate, glycerol triacrylate, pentaerythritol triallyl ether, N,N-divinylethylene urea, tetraallylammonium chloride, polyalkylene glycols esterified at least twice with acrylic acid and/or methacrylic acid, polyols such as pentaerythritol, sorbitol and glucose, and combinations thereof.

In some aspects of the method, the vinyl monomer(s) is/are selected from zwitterionic monomers having phosphobetaine, sulphobetaine, and/or carboxybetaine functionalities in their structure.

In some aspects of the method, the vinyl monomer(s) is/are selected from sulfobetaine 3-(dimethyl(methacryloylethyl)ammonium)propane sulfonate, the sulfobetaine 3-(2-methyl-5-vinylpyridine)propane sulfonate, the carboxy betaine N-3-methacrylamidopropyl-N,N-dimetyl-beta-ammonium propionate, the carboxy betaine N-2-acrylamidoethyl-N,N-dimethyl-beta-ammonium propionate, 3-vinylimidazole-N-oxide, 2-vinyl-pyridine-N-oxide, 4-vinyl-pyridine-N-oxide, and combinations thereof.

In some aspects of the method, the acid component of the esters of α,β-ethylenically unsaturated monocarboxylic acids with amino alcohols, such as acrylic acid or methacrylic acid. The amino alcohols, can be C₂-C₁₂ amino alcohols, C₁-C₈ mono-or C₁-C₈ dialkylated at the amine nitrogen, such as dialkylaminoethyl acrylates, dialkylaminoethyl methacrylates, dialkylaminopropyl acrylates and dialkylaminopropyl methacrylates. Other examples include N-methylaminoethyl acrylate, N-methylaminoethyl methacrylate, N,N-dimethylaminoethyl acrylate, N,N-dimethylaminoethyl methacrylate, N,N-diethylaminoethyl acrylate, N,N-diethylaminoethyl methacrylate, N,N-dimethylaminopropyl acrylate, N,N-dimethylaminopropyl methacrylate, N,N-diethylaminopropyl acrylate, N,N-diethylaminopropyl methacrylate, N,N-dimethylaminocyclohexyl acrylate, N,N-dimethylaminocyclohexyl methacrylate, and combinations thereof.

In some aspects of the method, the acid component in the mono-and diesters of α,β-ethylenically unsaturated dicarboxylic acids with amino alcohols, such as fumaric acid, maleic acid, monobutyl maleate, itaconic acid, and crotonic acid. Examples of amino alcohols are C₂-C₁₂amino alcohols, and C₁-C₈ mono-or C₁-C₈ dialkylated at the amine nitrogen.

In some aspects of the method, amides of α,β-ethylenically unsaturated monocarboxylic acids with dialkylated diamines can be, for example, dialkylaminoethylacrylamides, dialkylaminoethylmethacrylamides, dialkylaminopropylacrylamides, dialkylaminopropylacrylamides and combinations thereof. Individual examples are N-[2-(dimethyl-amino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(di-methylamino)butyl]acrylamide, N-[4-(dimethylamino)butyl]methacrylamide, N-[2-(diethylamino)-ethyl]acrylamide, and N-[2-(diethylamino)ethyl]methacrylamide.

In still other aspects of the method, the one or more optional vinyl monomer(s) different from those of Formula I, is/are preferably selected from monomer(s) such as, acrylamide, methacrylamide, N-isopropylacrylamide, N-methylmethacrylamide, N-vinylpyrrolidone, acrylonitrile, vinyl acetate, vinyl chloride, styrene, acrylic acid and salts thereof, methacryclic acid and salts thereof, vinylphosphonic acid and salts thereof, vinylsulfonic acid and salts thereof, maleic acid and salts thereof, itaconic acid and salts thereof, diallyldimethylammonium chloride (DADMAC), acrylamidopropyltrimethyl ammonium chloride (APTAC), methacrylamidopropyltrimethyl ammonium chloride, and combinations thereof.

In some aspects of the method, the vinylcarboxamide-containing polymers are produced using solution polymerization, inverse suspension polymerization, inverse emulsion polymerization, gel polymerization, or precipitation polymerization.

In some aspects of the method, the N-vinylcarboxamide-containing polymer can be in aqueous solution, a suspended particle, or a dry particulate. The particulate vinylcarboxamide-containing polymer can be in the form of granules, beads, powder, or particles.

In some aspects of the method, polymerization is carried out by radical means, for example by using radical polymerization initiators, for example peroxides, hydroperoxides, redox catalysts and azo compounds, which decompose into radicals. Examples of peroxides are alkali or ammonium peroxide sulfates, diacetyl peroxide, dibenzoyl peroxide, succinyl peroxide, di-tert-butyl peroxide, tert-butyl perbenzoate, tert-butyl perpivalate, tert-butyl peroxy-2-ethyl hexanoate, tert-butyl peroxy-2-ethyl hexanoate butyl permaleinate, cumene hydroperoxide, diisopropyl peroxidicarbamate, bis (o-toluoyl) peroxide, didecanoyl peroxide, dioctanoyl peroxide, dilauroyl peroxide, tert-butyl perisobutyrate, tert-butyl peracetate and di-tert-amyl peroxide. An example of a hydroperoxide is tert-butyl hydroperoxide. Examples of azo compounds that decompose into radicals are azo-bis-isobutyronitrile, azo-bis-(2-amidonopropane)dihydrochloride, 4,4′-azobis(4-cyanovaleric acid), 2,2′-azobis[2-methyl-N-(2-hydroxyethyl)propionamide], 2,2′-azobis(2-methylpropionamidine)dihydrochloride, 2,2′-azobis[2-(2-imidazolin-2-yl)propane]dihydrochloride, 2,2′-azobis[N-(2-carboxyethyl)-2-methylpropionamidine]tetrahydrate, 2,2′-azobis[2-(2-imidazolin-2-yl)propane], and 2-2′-azo-bis-(2-methyl-butyronitrile). Examples of redox catalysts include ascorbic acid/ferrous (II) sulfate/sodium peroxodisulfate, tert-butyl hydroperoxide/sodium disulfite, tert-butyl hydroperoxide/sodium hydroxy methane sulfinate, and H₂O₂/CuI.

In some aspects of the method, the inverse suspension polymerization can be carried out using one or more radical initiators currently used in this type of polymerization process.

In some aspects of the method, the vinylcarboxamide-containing polymer is hydrolyzed in an aqueous solution of base(s) or acid(s) to produce a vinylamine-containing polymer solution at a remote location.

In other aspects of the method, the base denotes an alkali hydroxide or alkali-metal hydroxide or alkaline-earth metal hydroxide or mixtures thereof.

In some aspects of the method, the vinylcarboxamide-containing polymer is added to the hydrolysis solution in an amount of from about 0.25 wt. % to about 45 wt. %, or from about 1 wt. % to about 20 wt. %, or from about 3 wt. % to about 10 wt. % of vinylcarboxamide-containing polymer, based on total weight of the aqueous medium, the vinylcarboxamide-containing polymer, and the acid(s) or base(s).

In other aspects of the method, the vinylcarboxamide-containing polymer is hydrolyzed from about 1% to about 100% based on number of vinylcarboxamide groups in the polymer.

In some aspects of the method, the hydrolysis process can be tracked using one or more of the following parameters, for example, time, pH, (Infra-Red) IR Spectroscopy, charge density, viscosity, Nuclear Magnetic Resonance (NMR), energy consumption of circulation pump, agitator torque and molecular weight measurements or combinations thereof.

In some aspects of the method, the hydrolysis is carried out at a temperature of about 35° C. to about 95° C., or from about 40° C. to about 80° C.

In some aspects of the method, the pH of the resulting vinylamine-containing polymer solution is adjusted to a value of from about pH 3 to about pH 12, or from about pH 6 to a pH of about 11 or higher.

In some aspects of the method, the N-vinylcarboxamide-containing polymer has a molecular weight in the range of from about 5,000 Daltons to about 5,000,000 Daltons, or from about 100,000 Daltons to about 1,000,000 Daltons, or from about 250,000 Daltons to about 750,000 Daltons.

In other aspects of the method, the hydrolysis process can be simplified by mathematically calculating the necessary amounts of base or acid required to achieve target hydrolysis level and running the reaction for a pre-determined amount of time. Thus, hydrolysis of PVFA can be made simple and effective, and the reaction time can be kept within reasonable limits while the desired hydrolysis level is achieved with sufficient accuracy.

The reaction cycle time for on-site process may be from about 10 to about 450 minutes, or from about 60 to about 210 minutes, or from about 70 to about 120 minutes.

The hydrolysis can be carried out either in acidic or basic conditions at a high temperature. The temperature dictates the rate of reaction and subsequently the cycle time. Higher temperature drives the process to completion faster. The process requires high temperature therefore, another alternative to achieve the desired temperature of the reaction mixture is the addition of hot water to the reactor, which can further help reduce cycle time. A short cycle time allows for multiple process cycles in a day.

Commercially, for quenching the hydrolysis reaction, the temperature is dropped, and the pH of the reaction mixture has to be adjusted in the range of from about 3 to about 12, or from about 6 to about 8. This process is time intensive as it could take several hours to bring the temperature down and then neutralize the reaction mixture. With the on-site process the reaction can be quickly quenched by addition of water in the reactor or in-line mixing as the product is pumped out of reactor. For pH neutralization a person skilled in the art can theoretically calculate the amount of base or acid required to neutralize the product.

The temperature and concentration dictate the rate of hydrolysis in addition to a plurality of factors. Thus, if the temperature and concentration can be brought down by addition of cold water, the hydrolysis can be slowed. In this way, the product can remain within the tolerance range for targeted hydrolysis level. This eliminates the need to neutralize the product. Therefore, with base mediated hydrolysis the final product could be a chlorine-free product making it environment friendly. This also allows for the on-site hydrolysis of a solid PVFA on an as required basis and utilized within a short amount of time. In addition, a combination of above-mentioned strategies could be utilized to reduce the cycle time.

An on-site hydrolysis process can also be done either in a reactor vessel or in a tubular reactor or in a re-circulating reactor setup.

In some aspects of the method, the vinylamine-containing polymer is added to a pulp suspension in an amount of from about 0.01 wt. % to about 5.0 wt. % based on the dry content of the pulp suspension.

In some aspects of the method, the vinylamine-containing polymer is used as a coagulant, a flocculant, a retention agent, a dry strength aid, a dewatering agent, and/or a sizing agent.

It is to be appreciated that any or all of the components above (e.g., monomers, modifiers, etc.) may be prepared or otherwise obtained (e.g., from commercial sources). Moreover, such components and/or the reagents used to prepare the same may originate from traditional (e.g., fossil-based) sources, or instead may be bio-based, i.e., prepared using biological methods and/or from products of such methods. In some embodiments, the method utilizes all bio-based components in the preparation of the vinylamine containing polymers. In other embodiments, at least a portion of a component is bio-based.

The embodiments of the current method are further defined in the following Examples. It should be understood that these examples are given by way of illustration only. Thus, various modifications of the present invention in addition to those shown and described herein will be apparent to those skilled in the art from the foregoing description. Although the invention has been described with reference to particular means, materials, and embodiments, it is to be understood that the invention is not limited to the particulars disclosed, and extends to all equivalents within the scope of the appended claims.

### EXAMPLES

The following examples demonstrate vinylamine-containing polymers of the current composition provide enhanced drainage and enhanced paper dry strength performance versus typical compositions when the compositions are used as additives during the paper making process. These examples and the data presented below better illustrate the benefits of the current composition and are not meant to be limiting.

### Example 1: Synthesis of PVFA Polymer A

A 1-liter reactor having a heating source and stirrer was heated to 60° C., at which time 300 grams (g) of solvent (Exxsol™ D40) and 0.4 milliliter (mL) of a polyacrylate based stabilizer (MUV) were added to the reactor and the mixture was stirred and the headspace was purged under nitrogen for a minimum of 15 minutes. To the reactor, 150 grams of 50% by weight N-vinylformamide (VFA) monomer solution in water, pre-mixed with 1250 parts-per-million (ppm) V50 thermal initiator and 500 ppm sodium sulphite, was added to the mixture while stirring was continued bringing the temperature of the mixture to about 35° C. After a dispersion period of at least 3 minutes, 500 parts-per-million (ppm) tert-butyl hydroperoxide was added to the reactor.

The temperature was increased to 90° C. to heat the reaction mixture. To remove the resultant water of the reaction, the contents where then distilled azeotropically. The nitrogen purge was removed, and a vacuum of 85 mbar applied to the system. The contents were then heated to approximately 85° C., over approximately 90 minutes. The resultant product had a bead appearance and was separated from the solvent by decanting and the product subsequently washed with acetone to aid in drying.

### Example-2: Synthesis of PVFA Polymer B

The polymer B was synthesized using same method as in example-2 except, the VFA monomer solution in water was premixed with 750 ppm V50 thermal initiator and 300 ppm sodium sulphite was used. And 300 ppm of tert-butyl hydroperoxide was used instead of 500 ppm.

### Example 3: Synthesis of Polyvinylamine Polymer A-h50

In this example, the following hydrolysis procedure was used. A 250 mL reaction vessel fitted with a condenser, pH and temperature probes, a temperature-controlled heating setup, an addition funnel, and a mechanical stirrer was used. To the reaction vessel, 6.25 grams of PVFA polymer, i.e., Polymer A, 0.15 grams of SMBS, and 135 grams of water were added and heated to a temperature of 80° C. To this mixture, 1.93 grams of NaOH was added. The temperature was kept stable at 80° C. for 180 minutes. Subsequently, the reaction was cooled and neutralized to pH 7 using concentrated hydrochloric acid. The degree of hydrolysis is monitored by FTIR analysis, in which intensity of the 1684 cm⁻¹ peak decreased, and intensity of a new broad peak at 3400 cm′ due to primary amine group increased. The reaction resulted in about a 50% hydrolyzed PVAM product, Polymer A-h50.

### Example 4: Synthesis of Polyvinylamine Polymer B-h50

In this example, the same method as in example 3 was used here except that PVFA polymer, i.e., Polymer B was used instead of Polymer A. The process resulted in a viscous polyvinylamine polymer, labelled as Polymer B-h50.

### Example 5: Synthesis of Polyvinylamine Polymer A-h80

A 250 mL reaction vessel fitted with a condenser, pH and temperature probes, a temperature-controlled heating setup, an addition funnel, and a mechanical stirrer was used. To the reaction vessel 135 grams of water, 2.8 grams of NaOH were added and heated to a temperature of 80° C. To this mixture, 5 grams of PVFA Polymer A, 0.15 grams of SMBS were added. The temperature was kept stable at 80° C. for 210 minutes. Subsequently, the reaction was cooled and neutralized to pH 7 using hydrochloric acid. The reaction resulted in 80% hydrolyzed PVAM product, Polymer A-h80.

### Example 6: Synthesis of Polymer Polyvinylamine A-h30

A 250 mL reaction vessel fitted with a condenser, pH and temperature probes, a temperature-controlled heating setup, an addition funnel, and a mechanical stirrer was used. To this reaction vessel, 140 grams of water and 4.2 grams of NaOH were added and heated to a temperature of 50° C. To this mixture, 7.5 grams of PVFA Polymer A, pre-mixed with 0.2 grams of SMBS were added to the mixture and the reaction temperature was increased to 70° C. The reaction was maintained at 70° C. for 75 minutes. Subsequently, the reaction was cooled by adding 40 mL of water and neutralized to pH 8 using concentrated hydrochloric acid. The reaction resulted in 30% hydrolyzed PVAM product, Polymer A-h30.

### Performance Evaluation

### Molecular Weight

The molecular weights of the PVAM polymers were compared using reduced specific viscosity (RSV). The RSV was determined at 0.20 wt. % in 1-Molar ammonium chloride using a MINIPV®-HX viscometer available from Cannon® instrument company. In general, higher RSV indicates higher molecular weight.

The inverse suspension polymerization allows for synthesis of higher molecular weight PVFA polymers compared to PVFA polymers synthesized by conventional solution polymerization. Post hydrolysis, higher molecular weight PVFA results in higher molecular weight PVAM. The RSV for a polyvinylamine resin (50% hydrolyzed) was used as a comparative sample (Comparative PVAM-1) and the hydrolyzed polymers Polymer A-h50 and Polymer B-h50, used for further performance evaluation are summarized in Table 1.

TABLE 1
Results from RSV
measurements.

| Polymer | RSV |
|---|---|
| Comparative | 1.9 |
| Polymer | |
| Polymer | 2.5 |
| A-h50 | |
| Polymer | 3.6 |
| B-h50 | |

### Evaluation of Strength Properties of Paper Samples

The strength of paper samples made with the polyvinylamine (PVAM) polymers from the above examples were compared with the strength of paper made with Comparative PVAM-1. Linerboard paper is made using an 8×8 inch² Nobel and Wood hand sheet mold. The paper pulp is a 100% recycled American Old Corrugated Container (AOCC) with 50 ppm hardness, 25 ppm alkalinity, 2.5% GPC D15F and 2000 μS/cm conductivity. The system pH is 7.0 and the pulp freeness is 380-420 CSF. The basis weight is 100 lbs. per 3000 ft². PVAM polymers prepared in the above examples are added as dry strength additive to the proportioner at the level of 0.1% and 0.2 weight % of active polymer based on dry paper pulp. Anionic polyacrylamide (Hercobond® 2800 from Solenis LLC) was also added at dosages equivalent to the PVAM. Additionally, Stalok® 300 and Perform® PC 8713 (cationic polyacrylamide) were also added to the proportioner. Ring Crush and STFI were used to measure the effect of PVAM polymers on strength of paper samples.

The dry strength test results are shown below in Table 2. Results of the PVAM polymers are normalized to the results from the control paper made without any PVAM or anionic polyacrylamide. The PVAM Polymer A-h50 and B-h50 from the examples, provided better Ring Crush and STFI performance than the Comparative PVAM-1.

TABLE 2
Results from strength
evaluation of paper samples

| | Dosage | Ring | |
|---|---|---|---|
| Polymer | (Wt %) | Crush | STFI |
| Blank | 0 | 100.0 | 100.0 |
| Comparative | 0.1 | 109.9 | 107.7 |
| PVAM | | | |
| Polymer | 0.1 | 114.5 | 112.4 |
| A-h50 | | | |
| Polymer | 0.1 | 109.5 | 120.5 |
| B-h50 | | | |

### Evaluation of Drainage Performance

The PVAM polymers were compared for their drainage performance utilizing a Dynamic Drainage Analyzer, test equipment available from AB Akribi Kemikonsulter Sundsvall, Sweden. A 750 milliliter (ml) sample volume at 0.9% consistency and a 0.500 mm opening/0.25 mm thread (32-mesh screen) were used in these tests. The test device applied a 300-mbar vacuum to the bottom of the separation medium and the time between the application of vacuum and the vacuum break point electronically measured, i.e., the time at which the air/water interface passes through the thickening fiber mat. Drainage testing was performed using paper pulp that was 100% American OCC recycled medium with 50 parts-per-million (ppm) hardness, 25 ppm alkalinity, 2.5% GPC D15F oxidized starch (Grain Processing Corp., Muscatine, Iowa) and about 2000-2100 μS/cm conductivity. The system pH was 7.0 and the pulp freeness was about 350-400 CSF for the recycled medium. A drainage index (DI) can be calculated as the drainage time for the control system with no additives divided by the time it takes for the system with additives. Results are shown in Table 3 below.

TABLE 3
Drainage Index (DI) Results

| Dosage | Comparative | Polymer | Polymer |
|---|---|---|---|
| (Wt. %) | PVAM-1 | A-h50 | B-h50 |
| 0.00 | 100.0 | 100.0 | 100.0 |
| 0.05 | 127.8 | 134.5 | 146.1 |
| 0.1 | 192.9 | 218.2 | 263.0 |
| 0.2 | 253.7 | 278.2 | 393.4 |

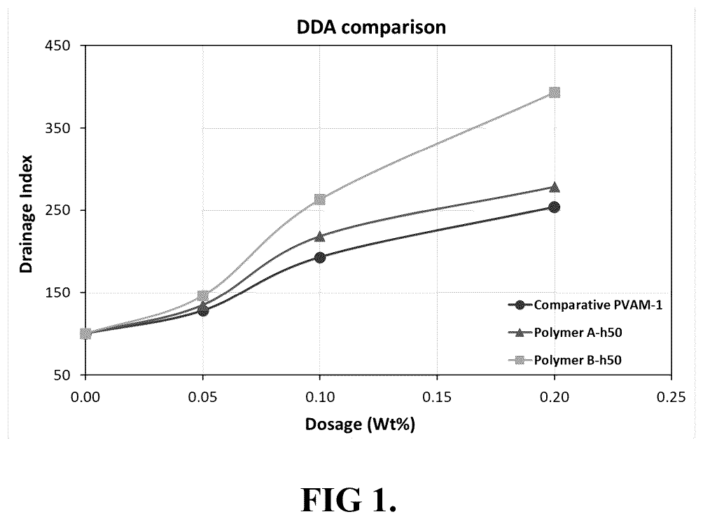

A higher DI demonstrates an improvement in drainage (see FIG. 1).

The drainage performance improves with an increase in molecular weight. The PVAM Polymer A-h50 and B-h50 from the examples provided better drainage performance compared to commercial polyvinylamine resin at equivalent dosage.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

We claim:

1. A method for producing a vinylamine-containing polymer comprising:
providing a vinylcarboxamide-containing polymer;
adding the vinylcarboxamide-containing polymer to an aqueous medium;
adding acid(s), or base(s) to the aqueous medium to hydrolyze the vinylcarboxamide-containing polymer, thus producing an aqueous solution of vinylamine-containing polymer; and
optionally adjusting the pH of the vinylamine-containing polymer solution.

2. The method according to claim 1, wherein the vinylcarboxamide-containing polymer has at least one N-vinylcarboxamide monomer of Formula I below: 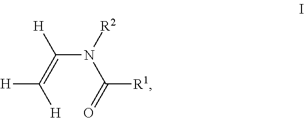
wherein R¹ and R², independently of one another, are H or C₁ to C₆ alkyl, and optionally one or more vinyl monomer(s) which are different from Formula I.

3. The method according to claim 1, wherein the N-vinylcarboxamide-containing polymer is a polymer or copolymer of N-vinylformamide.

4. The method according to claim 1, wherein the vinylcarboxamide-containing polymer is hydrolyzed at a different location from which the vinylcarboxamide-containing polymer was produced.

5. The method according to claim 1, wherein the hydrolyzed composition comprises from about 0.25 wt. % to about 45 wt. %, or from about 1 wt. % to about 20 wt. %, or from about 3 wt. % to about 10 wt. % vinylcarboxamide-containing polymer, based on total weight of the aqueous solution.

6. The method according to claim 1, wherein the degree of hydrolysis is monitored by measuring time, pH, IR spectroscopy, charge density, viscosity, NMR, energy consumption of circulation pump, agitator torque, measuring the molecular weight, and combinations thereof, of the aqueous solution.

7. The method according to claim 1, wherein the temperature of the aqueous medium is from about 35° C. to about 95° C., or from about 40° C. to about 80° C.

8. The method according to claim 1, wherein the vinylcarboxamide-containing polymer, the aqueous medium, and the acid(s) or base(s) are added to a reactor simultaneously; sequentially in either order; together as a premixed solution; or any combination thereof.

9. The method according to claim 1, wherein the pH of the aqueous solution of vinylamine-containing polymer is adjusted to a pH of about 3 to about 12, or from about 6 to about 8.

10. The method according to claim 1, wherein the N-vinylcarboxamide-containing polymer has a molecular weight in the range of from about 5,000 Daltons to about 5,000,000 Daltons, alternatively from about 100,000 Daltons to about 1,000,000 Daltons, alternatively from about 250,000 Daltons to about 750,000 Daltons.

11. The method according to claim 1, wherein the N-vinylcarboxamide monomer(s) is selected from N-vinylformamide, N-vinyl-N-methylformamide, N-vinylacetamide, N-vinyl-N-methylacetamide, N-vinyl-N-ethylacetamide, N-vinylpropionamide and N-vinyl-N-methyl-propionamide, N-vinylbutyramide, and combinations thereof.

12. The method according to claim 1, wherein one or more of the optional vinyl monomers is selected from acrylamide, methacrylamide, N-isopropylacrylamide, N-methylmethacrylamide, N-vinylpyrrolidone, acrylonitrile, vinyl acetate, vinyl chloride, styrene, quaternary ammonium salts of dimethylaminoethyl acrylate (DMAEA), quaternary ammonium salts of dimethylaminoethyl methacrylate (DMAEMA), diallyldimethylammonium chloride (DADMAC), acrylamidopropyltrimethyl ammonium chloride (APTAC), methacrylamidopropyltrimethyl ammonium chloride (MAPTAC); and/or one or more monomers from, acrylic acids, methacrylic acids, itaconic acids, crotonic acids, maleic acids, fumaric acids, 2-acrylamido 2-methylpropane sulfonic acids, vinyl sulfonic acids, vinyl phosphonic acids, allyl sulfonic acids, allyl phosphonic acids, styrene sulfonic acids, water-soluble salts of an alkali metal, water-soluble salts of an alkaline-earth metal, water-soluble salts of ammonium of these monomers, and combinations thereof.

13. The method according to claim 1, wherein the vinylamine-containing polymer is added to a pulp suspension in an amount of from about 0.01 wt. % to about 5.0 wt. %, or from about 0.25 wt. % to about 4 wt. % based on the dry wt. of the pulp suspension.

14. The method according to claim 1, wherein the vinylamine-containing polymer is used as a coagulant, a flocculant, a retention agent, a dry and/or wet strength aid, a dewatering agent, and/or a sizing agent in papermaking processes.
